(19) United States
(12) Patent Application Publication
(10) Pub. No.: US 2005/0253499 A1
(43) Pub. Date: Nov. 17, 2005

(54) Main electron lens for an electron gun

(76) Inventors: Nicolas Gueugnon, Dijon (FR); Nicolas Richard, Dijon (FR); Gregoire Gissot, Plombiere les Dijon (FR); Pierre Bizot, Marsannay la Cote (FR)

Correspondence Address: THOMSON LICENSING INC., PATENT OPERATIONS, PO BOX 5312, PRINCETON, NJ, 08543-5312, US

(21) Appl. No.: 11/122,504

(22) Filed: May 5, 2005

(30) Foreign Application Priority Data
May 12, 2004 (FR) 0450913

(51) Int. Cl. H01J 29/50; H01J 29/46

(52) U.S. Cl. 313/409; 313/414; 313/441

(57) ABSTRACT

The invention relates to a main electron lens for an in-line electron gun, comprising a first, focusing electrode and a second, accelerating electrode which are equipped with optical plates, each provided with a central hole and with two outer holes. The first optical plate is placed at a first distance from the aperture of the first electrode and the second optical plate is placed at a second distance from the aperture of the second electrode. The ratio of the first and second distances is determined by the formula:
L₁/L₂=A₁₁(δV_{d})²+A₁δV_{d}+A₀+C₀×Bias in which:
A₁₁, A₁, A₀ and C₀ are constants;
δV_{d} is the variation in the focus voltage that it is desired for the system to have; and Bias is the bias that it is desired for the system to have.

The invention relates to an in-line electron gun for a colour cathode-ray tube and more particularly to the main output lens of an electron gun.

### BACKGROUND OF THE INVENTION

An electron gun for a colour cathode-ray tube as shown in FIG. 1 comprises mainly:
three cathodes K, each emitting an electron beam;
an electrode G₁ in conjunction with the electrode G₂ initializes the formation of an electron beam along the ZZ′ axis based on the electrons emitted by the cathode. The electrode G₂ focuses the beam thus formed onto a focal point, called the “crossover”;
an electrode G₃ is used to accelerate the electrons;
an electrode G₄ constitutes, with the electrode G₃ and that part of the electrode G₅ facing G₄, an electron lens for prefocusing the electron beam;
electrodes G₅, G₆ and G₇ constitute quadripolar lenses and introduce, into the beam, a quadripolar effect so as to exert a compressive force on the electron beam in the vertical plane and a distortion in the horizontal plane; and
finally, an output lens, formed from the electrodes G₈ and G₉, is used to focus the electron beams onto the screen. The electrode G₈ performs the focusing of the beam onto the screen of the tube, while the electrode G₉ is used to accelerate the electrons.

FIGS. 2a to 2c show in detail a main lens for an electron gun.

In this colour electron gun, in which the three cathodes are aligned, the electrodes G₈ and G₉ each have an aperture, 9 and 10 respectively, of elongate shape and allowing overall treatment of the three beams, which also lie substantially in one and the same horizontal plane (within the context of an application in a television set for example). The apertures 9 and 10 of these electrodes are therefore elongate in a horizontal direction.

Each electrode G₈ and G₉ comprises an optical metal plate, 1 and 2 respectively, provided with three apertures (3 to 5 and 6 to 8) but are also aligned horizontally. Each aperture is used to treat one electron beam. The central aperture (4 in the case of the optical plate 1, and 7 in the case of the optical plate 2) has a rounded general shape elongate in the vertical direction. The outer—or lateral—apertures (3 and 5 in the case of the optical plate 1, and 6 and 8 in the case of the optical plate 2) have a rounded general shape elongate in the horizontal direction. The purpose of the particular shapes of these apertures is to correct the optical characteristics of the lens. A description of such an output lens for an electron gun will be found, for example, in Patent U.S. Pat. No. 5,142,189.

An electron gun is especially characterized by the following properties:
the focus voltage V_{d} applied to the electrode G₈ (see FIG. 3), this voltage making it possible to focus the electron beams onto the screen and especially, when there is no deflection of the beams, to focus them onto the centre of the screen;
the anode voltage applied to the electrode G₉ (see FIG. 3), this voltage allowing the electrons to be accelerated. In the case of an MDF (Modulation, Dynamic Focus) gun, the focus voltage is dynamic and has a variable voltage V_{d} applied to the electrode G₈ (see FIG. 3). In this case, the bias is defined as being the difference between V_{d} and V_{f} (Bias=V_{d}−V_{f}); and
the convergence of the three electron beams to the centre of the screen, that is to say the landing of the outer beams (or lateral beams) relative to the central beam onto the screen.

In general, the interactions between these three parameters (V_{d}, bias, convergence) are very strong as any modification of one of these three characteristics by geometrical modifications to the design has a strong effect on the other two, without resulting in a desired solution. In addition, the voltage V_{d} can be corrected by the gun length. The convergence of the three beams onto the centre of the screen may be adjusted by modifying its mechanical-S, that is to say the distance between the centre of the central hole in the optical plates 1 and 2 in the electrodes G₈ and G₉ and the centre of one of the lateral holes.

### SUMMARY OF THE INVENTION

The invention allows the abovementioned parameters (V_{d}, bias, convergence) to be adjusted by modifications introduced into the main lens without affecting the length of the electron gun or its mechanical-S.

The invention is applicable to MDF (Modulation, Dynamic Focus) and non-MDF guns.

The invention therefore relates to a main electron lens for an in-line electron gun, comprising a first, focusing electrode and a second, accelerating electrode each having an aperture, the shape of which is elongate in a horizontal direction. These electrodes comprise a first optical plate and a second optical plate, respectively, each provided with a central hole and with two outer holes lying in a direction parallel to the horizontal direction. The first plate is placed at a first distance L₁ from the aperture of the first electrode and the second optical plate is placed at a second distance L₂ from the aperture of the second electrode. The ratio of the first and second distances (L₁/L₂) is determined by the formula:
L₁/L₂=A₁₁(δV_{d})²+A₁δV_{d}+A₀+C₀×Bias
in which:
A₁₁, A₁, A₀ and C₀ are constants;
δV_{d} is the variation in the focus voltage that it is desired for the system to have; and
Bias is the bias that it is desired for the system to have.

Advantageously, the ratio of the first and second distances (L₁/L₂) is between 0.8 and 0.95 (0.8≦L₁/L₂≦0.95).

Preferably, since the central holes in the said optical plates have a general shape that is elongate in a vertical direction perpendicular to the horizontal direction and since the outer holes have a shape that is elongate in the horizontal direction, the possible variations in the vertical dimensions (δΦVᵢₙ, δΦVₒᵤₜ) of the central holes and of the outer holes are determined by the formula:
δΦVᵢₙ=δΦVₒᵤₜ=B₁×Bias
in which:
B₁ is a constant; and
Bias is the bias that it is desired for the system to have.

Advantageously, the dimension (Φᵢₙ) of the central holes in the vertical direction is between 3 mm and 8 mm with a possible variation (δΦᵢₙ) of this dimension between −0.5 mm and 0.5 mm (−0.5 mm≦δΦᵢₙ≦0.5 mm) and the dimension (Φₒᵤₜ) of the outer holes in the horizontal direction is also between 3 mm and 8 mm with a possible variation (Φₒᵤₜ) of this dimension between −0.5 mm and 0.5 mm (−0.5 mm≦δΦₒᵤₜ≦0.5 mm).

Preferably, the constant B₁ has a value of 121×10⁻⁵ and the constants A₀, A₁, A₁₁ and C₀ have the values:
A₀=876.48×10⁻³;
A₁=160.01×10⁻⁶;
A₁₁=174.52×10⁻⁹;
C₀=−36×10⁻⁶.

Advantageously, the voltage (V_{d}) of the first optical plate of the first electrode has a reference value of between 7000 volts and 9000 volts.

Also advantageously, the bias has a nominal value of between −500 volts and +500 volts.

The invention also provides for the modification of the convergence (Cₛ) to be obtained by modifying the distance of the second optical plate from the aperture of the second electrode.

The modification of the convergence is proportional to the modification of the said second distance (L₂) according to the equation:
δCₛ=±D₁(βL₂)
in which β is the proportion of modification of the said second distance (with for example −15%≦β≦+15%) and D₁ is a coefficient of value −10.

### BRIEF DESCRIPTION OF THE DRAWINGS

The various objects and features of the invention will become more clearly apparent from the description that follows and from the appended figures which show:

FIG. 1, an example of an electron gun to which the invention applies;

FIG. 2a, a detailed view of a cross section through a main lens of an electron gun;

FIGS. 2b and 2c, top views of the electrode G₈ of FIG. 2a, allowing the various elliptical shapes of the holes in the optical plate 1 and of the aperture 9 to be defined;

FIG. 3, an overall view of the upper part of the electron gun, allowing the various applied voltages to be defined;

FIG. 4, a chart showing the ratio L₁/L₂ as a function of the focus that it is desired to correct.

This chart has been shown for three bias values 0, 200 and −200 volts; and

FIG. 5, a curve plotting the variation in the bias at the centre of the screen as a function of the vertical ellipticity of the central hole.

### DETAILED DESCRIPTION OF THE PREFERED EMBODIMENT

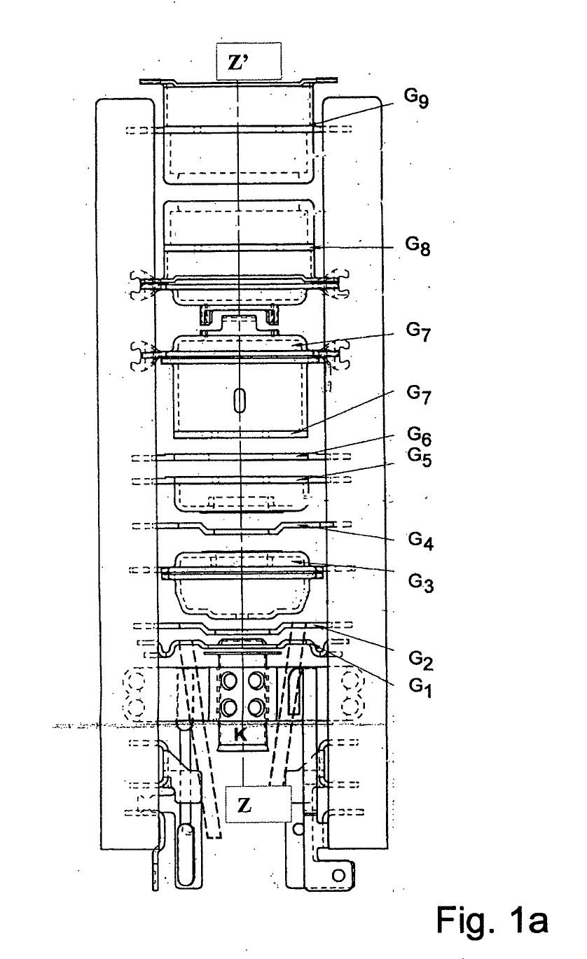

The invention therefore relates to a main output lens of an electron gun, allowing optimum adjustment of the desired voltage V_{d} and the desired bias by adjusting the vertical size of the holes in the main lens, which preserves the convergence of the three electron beams, by modifying the ratio of the respective positions of the optical plates with respect to the edges of the components (L₁, L₂, FIG. 1).

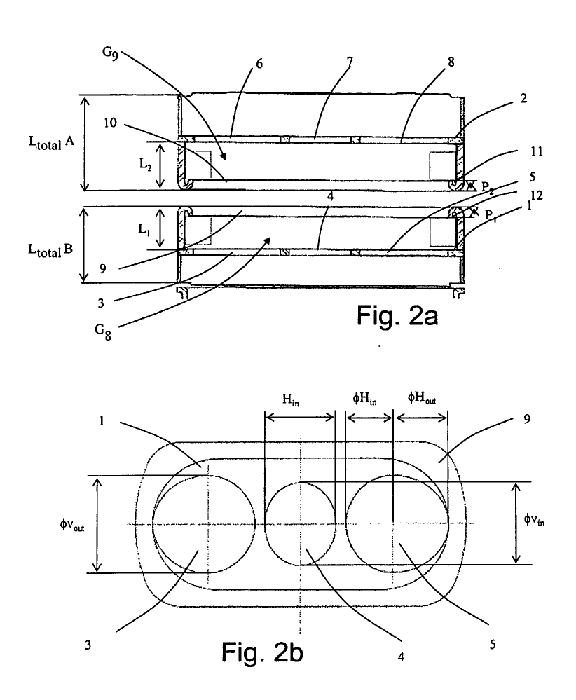

FIG. 2a shows a main lens for an electron gun. This lens comprises two electrodes G₈ and G₉ placed back-to-back and having two apertures 9 and 10 that face each other. Each aperture 9 and 10 is composed of two rectangular apertures 14 (see FIG. 2c) extended by two half-ellipses 13 and 15 of radius R (FIG. 2c).

The electrode G₈ has a height L₁ and the electrode G₉ has a height L₂.

The two apertures 9 and 10 are highly elongate in the horizontal direction. They comprise two identical material returns 11 and 12 of height P₁ and P₂.

In addition, the electrodes G₈ and G₉ each have an optical plate 1 and 2, respectively. Each optical plate is pierced by three holes 3, 4, 5 (in the case of the optical plate 1) and 6, 7 and 8 (in the case of the optical plate 2). These holes are placed in line, along the horizontal direction.

The optical plate 1 is positioned at a distance L₁ from the edge of the aperture 9 of the electrode G₈ and the optical plate 2 is positioned at a distance L₂ from the edge of the apertures 10 of the electrode G₉. The distances L₁ and L₂ are modified by moving the two optical plates 1 and 2 inside the two electrodes G₈ and G₉, while keeping the two lengths LₜₒₜₐₗA and LₜₒₜₐₗB constant.

The central holes 4 and 7 in the optical plates 1 and 2 are of elliptical general shape and have identical dimensions.

The outer holes 3, 5, 6 and 8 in the same optical plates have elliptical general shapes, as shown in FIG. 2b, comprising an inside horizontal diameter ΦHᵢₙ, an outside horizontal diameter ΦHₒᵤₜ and a vertical diameter ΦVₒᵤₜ. These outer holes 3, 5, 6 and 8 are symmetrical with respect to the central holes 4 and 7 and have the same dimensions.

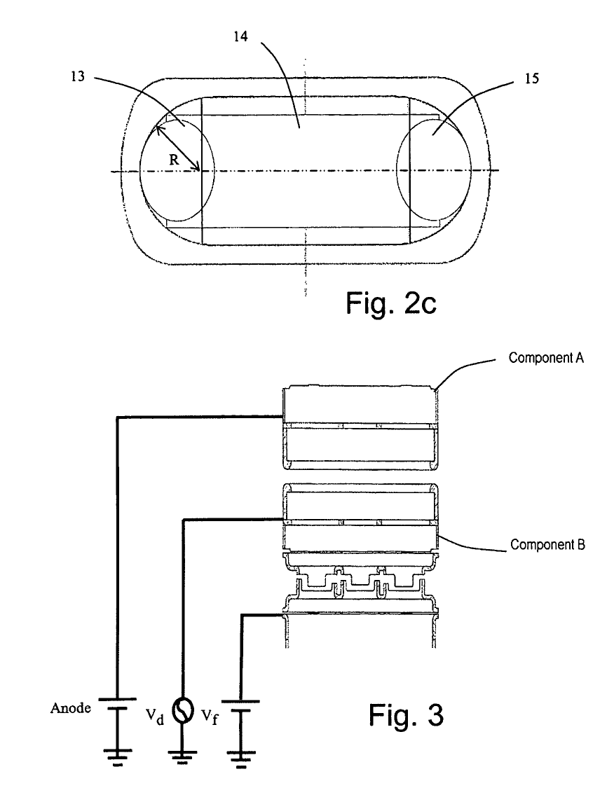

The electrode G₈ is connected to a dynamic voltage V_{d} (FIG. 3) and the electrode G₉ is connected to a voltage for the final acceleration of the electrons (anode).

According to the invention the V_{d} and bias parameters are adjusted by making adjustments to the optical plates 1 and 2.

A first adjustment acts on the ratio of L₁ to L₂, which varies between 0.80 and 0.95, thus making it possible to adjust the focus (V_{d}), while respecting the condition that the three beams converge on the centre of the screen.

A second adjustment relates to the vertical diameters of the outer holes and of the central hole, these diameters being represented by ΦVᵢₙ and ΦVₒᵤₜ in FIG. 2b, which allows the bias at the centre of the screen to be adjusted.

The invention thus makes it possible to adjust, independently, the solution (V_{d}, bias) and the convergence of the three beams on the centre of the screen.

The adjustment of the bias, by ΦVᵢₙ and ΦVₒᵤₜ, and the adjustment of the (V_{d}, bias) pair by L₁/L₂ are linked through the following polynomial models:
for the bias adjustment:
   δΦVᵢₙ=δΦVₒᵤₜ=B₁×Bias.
   In this formula:
the value of the coefficient B₁ is −121×10⁻⁵;
δΦVₒᵤₜ is the variation in the vertical size of the outer holes relative to a reference;
δΦVᵢₙ is the variation in the vertical size of the central hole relative to a reference.

To adjust the pair of parameters V_{d}, bias, there is the formula:
L₁/L₂=A₁₁(δV_{d})²+A₁δV_{d}+A₀+C₀×Bias

in which the values of the coefficients A₁₁, A₁, A₀ and C₀ are given in the table below:

| | A₀ | A₁ | A₁₁ | C₀ |
|---|---|---|---|---|
| coefficients | 876.48 × | 160.01 × | 174.52 × | −36 × 10⁻⁶ |
| | 10⁻³ | 10⁻⁶ | 10⁻⁹ | |

and with:
δV_{d}: variation in the focus relative to a reference (δV_{d}=V_{d,ref}−V_{d,final});
Bias: bias desired at the centre of the screen.

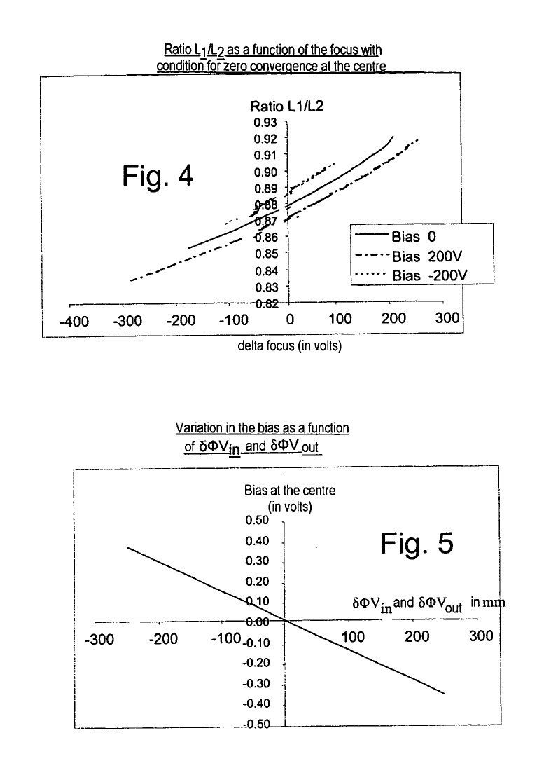

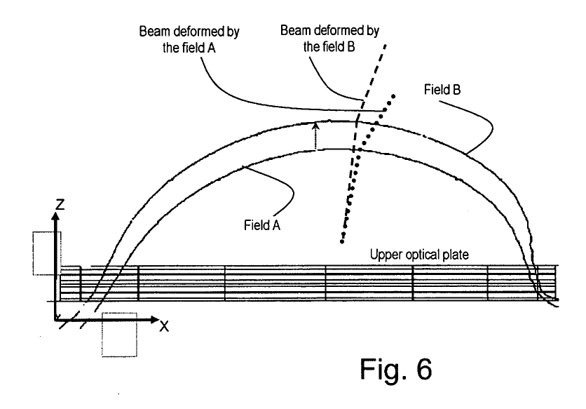

These equations have a good correlation coefficient (R²=0.99). These equations were determined from the charts shown in FIGS. 4 and 5.

In general, it may be considered that the variations in the diameters of the outer holes ΦVₒᵤₜ and of the central hole ΦVᵢₙ lie within the following ranges:
−0.5 mm<δΦVₒᵤₜ<0.5 mm for 3 mm<ΦVₒᵤₜ<8 mm
−0.5 mm<δΦVᵢₙ<0.5 mm for 3 mm<ΦVᵢₙ<8 mm and that the positions of the optical plates 1 and 2 in the electrodes G₈ and G₉ are such that:
0.8≦L₁/L₂≦0.95.

For the corresponding focus values:
7000 V<initial V_{d}<9000 V and −500 V<δV_{d}<500 V with the equation
   V_{d}(desired)=V_{d}(initial)+δV_{d}.

For the bias variations:
−500 V<Bias<500 V.

The invention also makes it possible to adjust the convergence of the electron gun.

It should firstly be pointed out that the static convergence is in fact the deviation in position on the screen between the images of the two cathodes that are furthest apart, in such a way that three impact spots are observed at the centre of the screen instead of a single coincident one. The value of the static convergence (Cₛ) is easily measured experimentally, the approach consisting in determining the distance of the two beams furthermost apart that land at the centre of the screen. In practice, it is sufficient to record the Cartesian coordinates of the blue beam in order to subtract them from those of the red beam in the XY plane at the centre of the screen. The static convergence (Cs) is a dimension which is calculated only on the horizontal (X) axis of the screen—the deviation that might be encountered along the Y axis of the gun would in fact be a problem associated with the poor quality of alignment of the grids of the entire gun and/or with an assembly defect.

The static convergence (Cₛ) may be expressed as follows:
X_{centre,BLUE}−X_{centre,RED}
where
Cₛ: static conversion of the two outer beams at the centre of the screen;
X_{centre,BLUE}: position of the outer beam at the centre of the screen along the horizontal (X) axis, which symbolizes the blue cathode of the electron gun; and
X_{centre,RED}: the position of the outer beam at the centre of the screen along the horizontal (X) axis that symbolizes the red cathode of the electron gun.

The convergence depends on:
the passage of the outer beams through each of the electrodes;
the choice of the mechanical-S (the distance of the outer holes with respect to the main central axis of the gun);
but also the intrinsic properties of each of the electron-optics lenses that allow the “equipotential” field lines to penetrate, in order to orient the outer electron beams at the centre of the screen.

These field lines, owing to their shape and their penetration through the grid apertures, are capable of correcting quite slight convergence defects at the centre of the screen. The electrostatic field seen by the outer beams is not exactly the same as that felt by the central beam. The trajectories of the outer electrons are less well centred on the grids and their oblique inclination relative to the central beam makes them more sensitive to variations in the field lines. A change of position, along the axis of the electron gun, of the optical plate 2 of the electrode G₉, by an increase in the distance L₂, results in a displacement of the field lines. Thus, in FIG. 6 the field lines, such as A, move towards the field lines such as B, and there is therefore a slightly different curvature of the field, which causes a different inclination between the two electron trajectories. The effect is sufficient to correct a static convergence adjustment problem of ±1 mm.

To correct the static convergence, provision is therefore made to modify the distance L₂ by an amount βL₂=±βL₂.

The static convergence Cₛ is expressed as a linear function of the distance L₂ by:
Cₛ=D₁L₂+D₀.

The convergence correction can therefore be written as:
δCₛ=D₁δL₂;
δCₛ=±D₁(βL₂)

In these equations, D₁ and D₀ have the following values:
D₁=−10 and D₀=40.

However, as was seen previously, the bias is proportional to the radio L₁/L₂. A modification of L₂ therefore results in a modification of the bias. This is because:
Bias=±E₁L₂+E₀.

A modification of the bias is therefore given by the equation:
δbias =±E₁(βL₂)

This has to be corrected, as was described above, by modifying the vertical dimensions of the holes in the optical plates 1 and 2 (δΦVᵢₙ=δΦVₒᵤₜ=B₁×Bias).

In these equations, the coefficients E₁ and D₀ have the following values: E₁=500 and E₀=−1950.

It may therefore be seen that, for a variation in the distance L₂ of value:
δL₂=βL₂
a static convergence defect δCₛ is corrected between the following limits:
−D₁(βL₂)≦δCₛ≦+D₁(βL₂).

This results in a bias variation of:
−E₁(βL₂)≦δBias≦+E₁(βL₂)
where −15%≦β≦+15%.

A modification δL₂=βL₂ makes it possible to correct a static convergence defect with a value:
δCₛ=±D₁(βL₂),
which results in a variation in the bias with a value δBias=±E₁(βL₂)

For example:
−15%≦β≦+15%;
−1.5 mm≦δCₛ≦+1.5 mm;
−75 volts≦δBias≦+75 volts.

This bias variation must be corrected, as indicated above, by modifying the dimensions along the vertical direction of the holes in the optical plates 1 and 2 (δΦVᵢₙ=δΦVₒᵤₜ=B₁×Bias).

1. Main electron lens for an in-line electron gun, comprising a first focusing electrode and a second accelerating electrode each having an aperture the shape of which is elongate in a horizontal direction, the said electrodes comprising a first optical plate and a second optical plate respectively, each provided with a central hole and with two outer holes lying in a direction parallel to the horizontal direction, the first optical plate being placed at a first distance from the aperture of the first electrode and the second optical plate being placed at a second distance from the aperture of the second electrode, wherein the ratio of the first and second distances is determined by the formula:
L₁/L₂=A₁₁(δV_{d})²+A₁δV_{d}+A₀+C₀×Bias
in which:
A₁₁, A₁, A₀ and C₀ are constants;
δV_{d} is the variation in the focus voltage that it is desired for the system to have; and
Bias is the bias that it is desired for the system to have.

2. Main electron lens for an in-line electron gun according to claim 1, wherein the ratio of the first and second distances is between 0.8 and 0.95 (0.8≦L₁/L₂≦0.95).

3. Main electron lens for an in-line electron gun according to claim 1 wherein since the central holes in the said optical plates have a general shape that is elongate in a vertical direction perpendicular to the horizontal direction and since the outer holes have a shape that is elongate in the horizontal direction, the possible variations in the said vertical dimensions of the central holes and of the outer holes are determined by the formula:
δΦVᵢₙ=δΦVₒᵤₜ=B₁×Bias
in which:
B₁ is a constant; and
Bias is the bias that it is desired for the system to have.

4. Main electron lens for an in-line electron gun according to claim 3, wherein the dimension (Φᵢₙ) of the central holes in the vertical direction is between 3 mm and 8 mm with a possible variation (δΦᵢₙ) of this dimension between −0.5 mm and 0.5 mm (−0.5 mm≦δΦᵢₙ≦0.5 mm) and in that the dimension (δΦₒᵤₜ) of the outer holes in the horizontal direction is also between 3 mm and 8 mm with a possible variation (δΦₒᵤₜ) of this dimension between −0.5 mm and 0.5 mm (−0.5 mm≦δΦₒᵤₜ≦0.5 mm).

5. Main electron lens for an in-line electron gun according to claim 3, wherein the constant B₁ has a value of 121×10⁻⁵.

6. Main electron lens for an in-line electron gun according to claim 1, wherein constants A₀, A₁, A₁₁ and C₀ have the values:
A₀=876.48×10⁻³;
A₁=160.01×10⁻⁶;
A₁₁=174.52×10⁻⁹;
C₀=−36×10⁻⁶.

7. Main electron lens for an in-line electron gun according to claim 1, wherein the voltage of the first optical plate of the first electrode has a reference value of between 7000 volts and 9000 volts.

8. Main electron lens for an in-line electron gun according to claim 1, wherein the bias voltage has a nominal value of between −500 volts and +500 volts.

9. Main electron lens for an in-line electron gun according to claim 1, wherein a modification of the convergence is obtained by modifying the second distance of the second optical plate from the aperture of the second electrode.

10. Main electron lens for an in-line electron gun according to claim 9, wherein the modification of the convergence is proportional to the modification of the said second distance according to the equation:
δCₛ=±D₁(βL₂)
in which β is the proportion of modification of the said second distance and D₁ is a coefficient of value −10.

11. Main electron lens for an in-line electron gun according to claim 10, wherein the proportion of modification of the said second distance is between −15% and +15%.
